(19) United States
(12) Patent Application Publication
(10) Pub. No.: US 2016/0364433 A1
(43) Pub. Date: Dec. 15, 2016

(54) APPARATUS FOR ESTIMATING USABILITY AND QUALITY OF DATA

(71) Applicant: INFORIENCE INC., Daejeon (KR)

(72) Inventor: Jin Hyuk Choi, Daejeon (KR)

(73) Assignee: INFORIENCE INC., Daejeon (KR)

(21) Appl. No.: 14/921,376

(22) Filed: Oct. 23, 2015

(30) Foreign Application Priority Data
Jun. 11, 2015 (KR) 10-2015-0082339

(51) Int. Cl. G06F 17/30

(52) U.S. Cl. CPC G06F 17/30371; G06F 17/30525; G06F 17/3053; G06F 17/30353

(57) ABSTRACT

Disclosed is an apparatus for estimating a usability and a quality of data. The apparatus for estimating a usability and a quality of data includes: a database configured to store a quality of first analysis data according to comment information on a data pattern included in the first analysis data and interpretation information on a part corresponding to a set search pattern among the first analysis data; and a data estimating unit configured to automatically derive a quality of second analysis data according to the comment information and the interpretation information allocated to a part of the second analysis data corresponding to the data pattern and the search pattern.

### TECHNICAL FIELD

The present invention relates to an apparatus for estimating a usability and a quality of data, a computer program for estimating a usability and a quality of data, and a recording medium for storing the computer program.

### BACKGROUND

In recent years, the interest in big data has been increased. Data generated from various devices may be analyzed as the big data to provide information and a service required from a user.

When processing the big data, various opinions and interpretations of user should be reflected in a data analysis procedure so that excellent information and service may be provided.

Accordingly, as disclosed in Korean patent publication 10-2015-0062637 (publication date: Jun. 8, 2015), researches and studies have been performed toward a technology which can reflect an opinion and interpretation of a user in interpretation of big data in an analysis procedure.

### SUMMARY

The prevent invention has been made in an effort to solve the above-described problems, and provides an apparatus for estimating a usability and a quality of data, a recording medium, and a computer program so as to automatically derive a quality of analysis data.

In accordance with an aspect of the present invention, an apparatus for estimating a usability and a quality of data includes: a database configured to store a quality of first analysis data according to comment information on a data pattern included in the first analysis data and interpretation information on a part corresponding to a set search pattern among the first analysis data; and a data estimating unit configured to automatically derive a quality of second analysis data according to the comment information and the interpretation information allocated to a part of the second analysis data corresponding to the data pattern and the search pattern.

In accordance with another aspect of the present invention, an apparatus for estimating a usability and a quality of data includes: a database configured to store a quality of first analysis data according to comment information on a data pattern included in the first analysis data; and a data estimating unit configured to automatically derive a quality of second analysis data according to the comment information allocated to a part of the second analysis data similar to or identical with the data pattern.

In accordance with another aspect of the present invention, an apparatus for estimating a usability and a quality of data includes: a database configured to store a quality of first analysis data according to interpretation information on a part corresponding to a set search pattern among the first analysis data; and a data estimating unit configured to automatically derive a quality of second analysis data according to the interpretation information allocated to a part of the second analysis data similar to or identical with the search pattern.

The first analysis data comprises a plurality of time series data, and the data estimating unit derives the quality of the second analysis data through reference time series data among the plurality of time series data.

The reference time series data includes time series data having the best quality among the plurality of time series data.

The apparatus further includes a qualitative quality calculating unit configured to calculate the quality of the first analysis data according to a frequency of a term included in the comment information and a frequency of a term included in the interpretation information through a morphological analyzer.

The apparatus further includes a qualitative quality calculating unit configured to calculate the quality of the first analysis data according to a frequency of a term included in the comment information through a morphological analyzer.

The apparatus further includes a qualitative quality calculating unit configured to calculate the quality of the first analysis data according to a frequency of a term included in the interpretation information through a morphological analyzer.

The data estimating unit calculates the quality of the second analysis data according to a frequency of a term included in the comment information and a frequency of a term included in the interpretation information allocated to a part of the second analysis data through a morphological analyzer.

The data estimating unit calculates the quality of the second analysis data according to a frequency of a term included in the comment information allocated to a part of the second analysis data through a morphological analyzer.

The data estimating unit calculates the quality of the second analysis data according to a frequency of a term included in the interpretation information allocated to a part of the second analysis data through a morphological analyzer.

The apparatus further includes a quantitative quality calculating unit configured to calculate the quality of the first analysis data according to a length of an interval corresponding to the comment information and the interpretation information.

The apparatus further includes a quantitative quality calculating unit configured to calculate the quality of the first analysis data according to a length of an interval corresponding to the comment information.

The apparatus further includes a quantitative quality calculating unit configured to calculate the quality of the first analysis data according to a length of an interval corresponding to the interpretation information.

The data estimating unit calculates the quality of the second analysis data according to a length of an interval corresponding to the comment information and the interpretation information allocated to a part of the second analysis data.

The data estimating unit calculates the quality of the second analysis data according to a length of an interval corresponding to the comment information allocated to a part of the second analysis data.

The data estimating unit calculates the quality of the second analysis data according to a length of an interval corresponding to the interpretation information allocated to a part of the second analysis data.

The data estimating unit derives a part of the second analysis data corresponding to the data pattern by performing convolution with respect to an area of the first analysis data corresponding to the data pattern and the second analysis data.

The data estimating unit derives a part of the second analysis data corresponding to the search pattern among the segmented second analysis data.

### BRIEF DESCRIPTION OF THE DRAWINGS

The objects, features and advantages of the present invention will be more apparent from the following detailed description in conjunction with the accompanying drawings, in which:

FIG. 1 and FIG. 2 illustrate an apparatus for estimating a usability and a quality of data according to an embodiment of the present invention;

FIG. 3 is a graph illustrating an example of comment information;

FIG. 4 and FIG. 5 illustrate an example of interpretation information; and

FIG. 6 illustrates an operation of a quantitative quality calculating unit.

### DETAILED DESCRIPTION

Embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

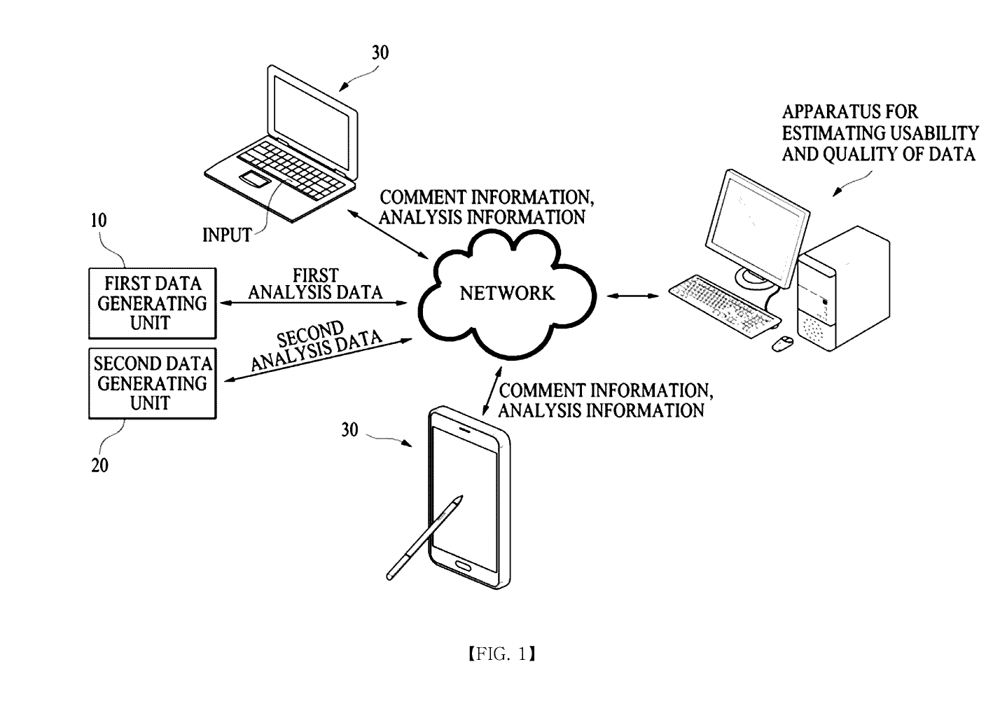

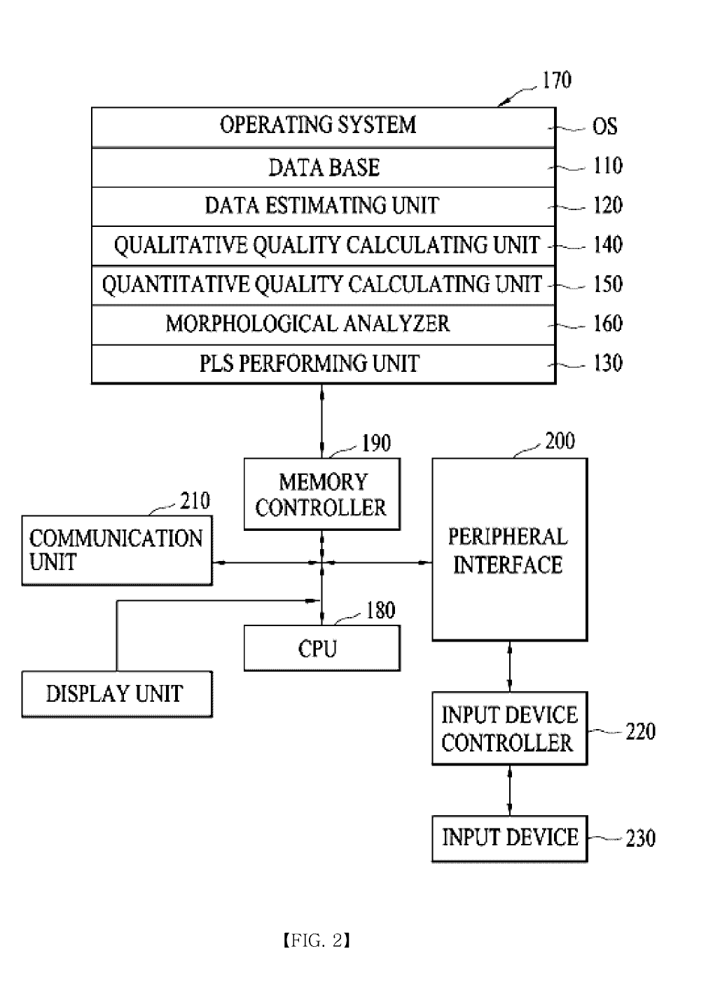

FIG. 1 and FIG. 2 illustrate an apparatus for estimating a usability and a quality of data according to an embodiment of the present invention. The apparatus for estimating a usability and a quality of data according to an embodiment of the present invention may include a database 110 and a data estimating unit 120.

The database 110 may store a quality of first analysis data according to comment information on a data pattern included in the first analysis data, and interpretation information on a part corresponding to a set search pattern among the first analysis data.

On the other hand, the database 110 may store a quality of the first analysis data according to the comment information on the data pattern included in the first analysis data or store quality of the first analysis data according to interpretation information on a part corresponding to the set search pattern among the first analysis data.

The first analysis data may be generated by a first data generating unit 10 and may include time series data. Although a single first data generating unit 10 is illustrated in FIG. 1, the present invention is not limited thereto. A plurality of the first data generating units 10 may generate time series data respectively.

The first analysis data may include a plurality of time series data. At least one of the comment information and the interpretation information may be related to each time series data.

A user may input comment information on the data pattern included in the first analysis data through a terminal 30, and the first analysis data and the comment information may be stored while being associated with each other.

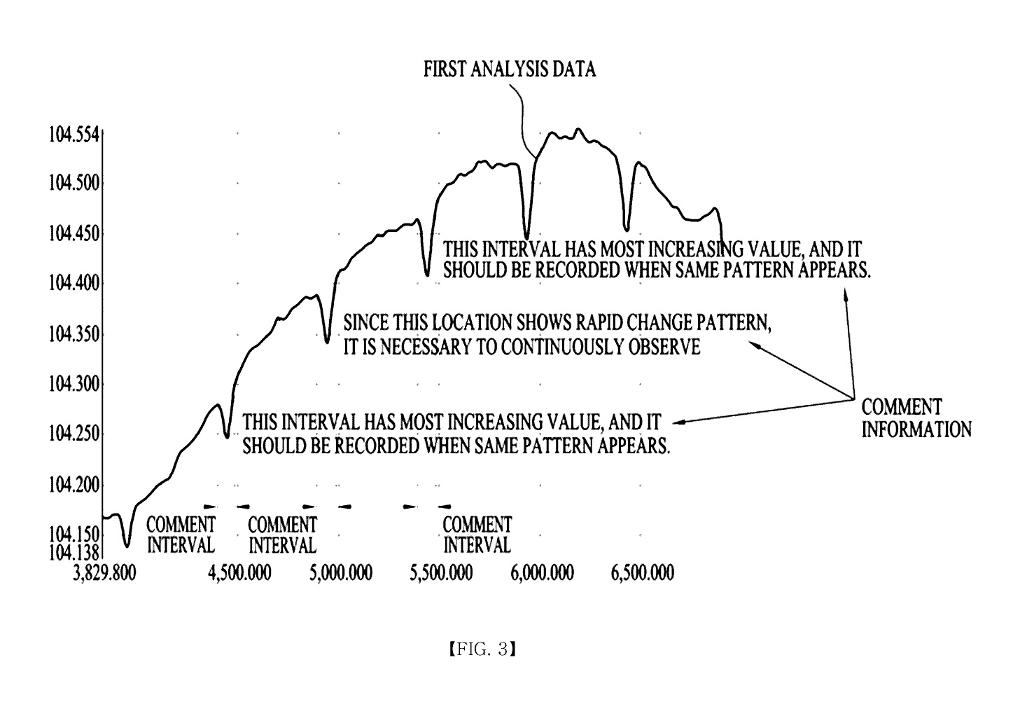

For example, as shown in FIG. 3, the user may input comment information on an interval of a data pattern in which the first analysis data is rapidly changed.

In this case, the user may set the interval of the data pattern corresponding to comment information, that is, a comment interval. The terminal 30 may transmit the comment interval and values of the first analysis data existing in the comment interval to the apparatus for estimating a usability and a quality of data according to an embodiment of the present invention.

The apparatus for estimating a usability and a quality of data according to an embodiment of the present invention may store the comment information, the comment interval, and the values of the first analysis data existing in the comment interval while being associated with each other.

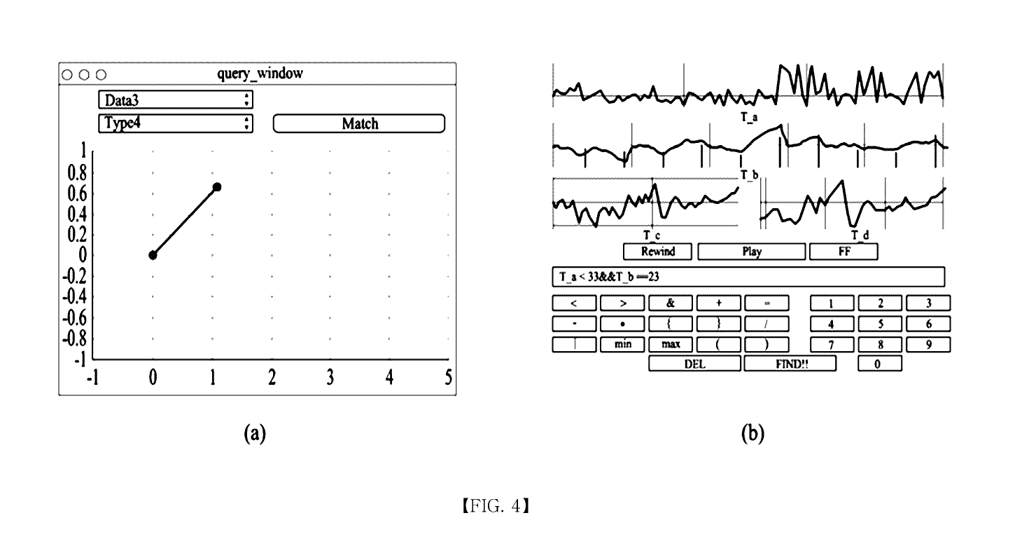

Further, the user may set the search pattern desired to be searched by the user by inputting the search pattern in a query form through the terminal 30. For example, as shown in FIG. 4(A), the user may input a graphic type query like a straight line having a specific slope through a mouse, a touch of a finger, or a stylus.

Accordingly, the apparatus for estimating a usability and a quality of data according to an embodiment of the present invention may extract a part having the slope among the first analysis data. For example, the terminal 30 may calculate and transmit a slope of a straight line through coordinates of both end points of the straight line in FIG. 4(A) to the apparatus for estimating a usability and a quality of data according to an embodiment of the present invention.

A piecewise linear segmentation (PLS) performing unit 130 of the apparatus for estimating a usability and a quality of data according to an embodiment of the present invention may convert the first analysis data into segment data which is connected by straight lines through a PLS method. Since the PLS method is well known to an ordinary person skilled in the art, a detailed description thereof is omitted.

The segment scheme is not limited to the PLS method, but various segment schemes may be applicable to the present invention.

The PLS performing unit 130 may extract the set search pattern among straight lines configuring segmentation data, that is, straight lines having an input slope.

FIG. 4(A) illustrates a graphic type query, but the present invention is not limited thereto. As shown in FIG. 4(B), the user may set the search pattern by inputting characteristics of the search pattern with a text or a symbol.

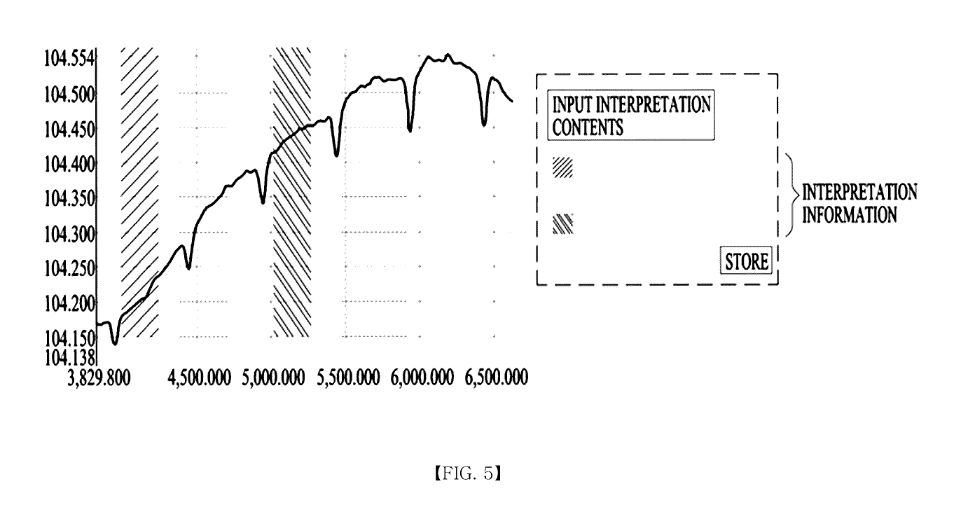

As shown in FIG. 5, the user may interpret results searched by the PLS performing unit 130, and may transmit the above interpretation information to the apparatus for estimating a usability and a quality of data according to an embodiment of the present invention through the terminal (30).

The apparatus for estimating a usability and a quality of data according to an embodiment of the present invention may store the set search pattern, the result searched by the PLS performing unit 130, and the interpretation information in the database 110 while being associated with each other.

In the meantime, the apparatus for estimating a usability and a quality of data according to an embodiment of the present invention may further include a qualitative quality calculating unit 140 and a quantitative quality calculating unit 150. The qualitative quality calculating unit 140 and the quantitative quality calculating unit 150 may calculate quality of the first analysis data according to at least one of the comment information and the interpretation information.

Hereinafter, the qualitative quality calculating unit 140 is described first and then the quantitative quality calculating unit 150 is described.

The qualitative quality calculating unit 140 may calculate the quality of the first analysis data according to at least one of a frequency of a term included in the comment information and a frequency of a term included in the interpretation information through a morphological analyzer 160.

The morphological analyzer 160 may extract terms included in the comment information and terms included in the interpretation information. In this case, the first analysis data may include plurality of time series data.

The qualitative quality calculating unit 140 may derive the number of times (TF) of each term provided from at least one of the comment information and the interpretation information on a single time series data.

For example, as shown in FIG. 3 and FIG. 5, the comment information and the interpretation information may be formed of a sentence, and a plurality of terms forming each sentence may be extracted by the morphological analyzer 160.

Accordingly, the qualitative quality calculating unit 140 may derive the number of times of each term provided from at least one of the comment information and the interpretation information on a single time series data.

Further, the qualitative quality calculating unit 140 may derive the number of times (DF) provided from at least one of the comment information and the interpretation information on different time series data.

Through the above procedure, the TF and the DF with respect to a single term may be derived.

The DF may be a result of counting the amount of the term which is commonly shared in at least one of the comment information and the interpretation information on different time series data.

When the DF of the term is great, it means that the term may be applicable to a plurality of different time series data. Thus, the term having a great DF may be general, that is, may have a low importance.

Accordingly, the qualitative quality calculating unit 140 may calculate the importance for the term by calculating the TF/DF. Accordingly, as the DF is increased, the importance of the term may be decreased, whereas as the TF is increased, the importance of the term may also be increased.

In the above method, the qualitative quality calculating unit 140 may calculate the importance of the term forming at least one of the comment information and the interpretation information.

If the importance of each term is calculated, the qualitative quality calculating unit 140 may calculate a qualitative quality Ta of each time series data. For example, when at least one of the comment information and the interpretation information with respect to specific time series data is formed of n terms, the qualitative quality calculating unit 140 may calculate the qualitative quality Ta of the specific time series data by calculating an average value for the importance of the n terms.

Hereinafter, the quantitative quality calculating unit 150 is described.

The quantitative quality calculating unit 150 may calculate the quality of the first analysis data according to a length of an interval corresponding to at least one of the comment information and the interpretation information.

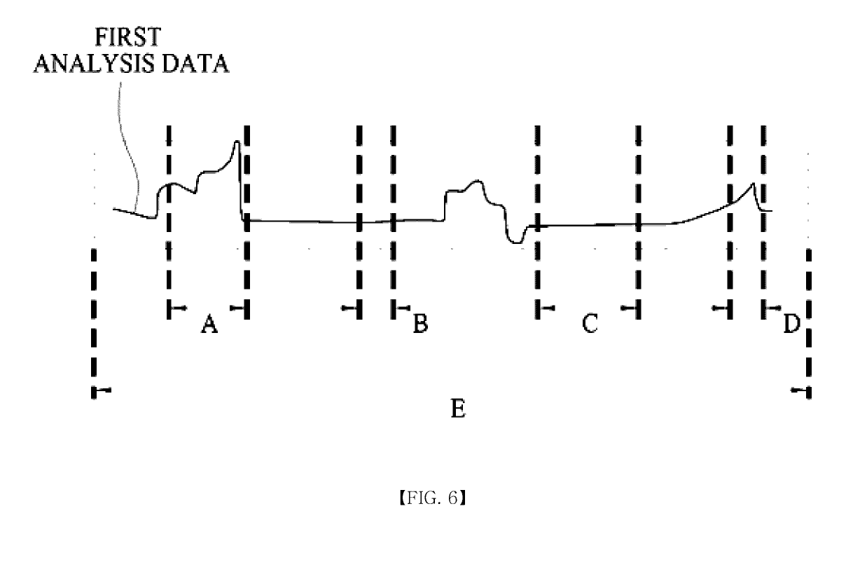

For example, as shown in FIG. 6, A, B, C, and D represent intervals to which the comment information or the interpretation information is input. E represents the whole interval of the first analysis data. The quantitative quality calculating unit 150 may calculate a quantitative quality Tb of the first analysis data by calculating (A+B+C+D)/E.

As described above, the apparatus for estimating a usability and a quality of data according to an embodiment of the present invention may derive the qualitative quality Ta and the quantitative quality Tb of the first analysis data. The apparatus for estimating a usability and a quality of data may derive a total quality QU by integrally considering the qualitative quality Ta and the quantitative quality Tb.

That is, the apparatus for estimating a usability and a quality of data according to an embodiment of the present invention may calculate the total quality QU for the first analysis data. The QU may be α*Ta+β*Tb. The α and the β may be weights for the qualitative quality Ta and the quantitative quality Tb, respectively. A sum of the α and the β may be 1.

As described above, the apparatus for estimating a usability and a quality of data may derive the importance of each term included in at least one of the comment information and the interpretation for the first analysis data and the quality of the first analysis data. The importance of each term and the quality of the first analysis data may be stored in the database 110.

Next, the data estimating unit 120 shown in FIG. 2 is described.

As described above, the apparatus for estimating a usability and a quality of data according to an embodiment of the present invention may establish the database 110 through the first analysis data. Alternatively, the data estimating unit 120 of the apparatus for estimating a usability and a quality of data according to an embodiment of the present invention may derive the quality of the second analysis data through the pre-established database 110.

That is, the first analysis data may be used for the purpose of establishing the database 110. The quality of the second analysis data may be derived through the established database 110.

The data estimating unit 120 may automatically derive the quality of a second analysis data according to the comment information and the interpretation information allocated to a part of the second analysis data corresponding to the data pattern and the search pattern.

Alternatively, the data estimating unit 120 may automatically derive the quality of the second analysis data according to the comment information allocated to a part of the second analysis data corresponding to the data pattern, or may automatically derive the quality of the second analysis data according to the interpretation information allocated to a part of the second analysis data corresponding to the search pattern.

That is, the user does not input the comment information or the interpretation information on the second analysis data through the terminal 30. The data estimating unit 120 may allocate one of the comment information and the interpretation information stored in the database 110 to the second analysis data.

In this case, the data estimating unit 120 may automatically derive the quality of the second analysis data through at least one of the data pattern and the search pattern of the first analysis data.

For example, when the first analysis data includes a plurality of time series data, the data estimating unit 120 may derive the quality of the second analysis data through reference time series data among the plurality of time series data.

In this case, the reference time series data may include time series data having the best quality among the plurality of time series data.

As described above, the quality of each time series data included in the first analysis data may be calculated. Accordingly, there is time series data having the highest quality among the entire time series data.

The higher the quality of the time series data is, the higher the importance is. Accordingly, the data estimating unit 120 may calculate the quality of the second analysis data through the data pattern and the search pattern of the time series data having the highest quality.

In this case, the data estimating unit 120 may derive a part of the second analysis data corresponding to the data pattern by performing convolution with respect to an area of the first analysis data corresponding to the data pattern and the second analysis data.

As described above, since the comment information, the comment interval, and the first analysis data existing in the comment interval are stored in the database 110 while being associated to each other, the data estimating unit 120 may perform convolution with respect to the values of the reference time series data existing in the comment interval and the second analysis data.

In addition, the data estimating unit 120 may derive a part of the second analysis data corresponding to the search pattern among the second analysis data segmented through the PLS performing unit 130.

In this case, the data estimating unit 120 may derive a part of the second analysis data corresponding to the search pattern of the reference time series data among the segmented second analysis data.

That is, the data estimating unit 120 may extract a part of the second analysis data similar to at least one of a data pattern area and a search pattern area of the first analysis data, and allocate comment information or interpretation information with respect to at least one of the data pattern and the search pattern to the extracted part of the second analysis data.

To this end, the data estimating unit 120 may read the comment information and the interpretation information with respect to the data pattern and the search pattern from the database 110.

In this case, similar to the first analysis data, the second analysis data may include a plurality of time series data. At least one of the comment information and the interpretation information may be allocated to each time series data of the second analysis data by comparing each time series data of the second analysis data with the above mentioned reference time series data.

As described above, if at least one of the comment information and the interpretation information read from the database 110 is allocated to the part of the second analysis data, the data estimating unit 120 may automatically calculate the quality of the second analysis data.

Further, a procedure of deriving the quality of the second analysis data may be similar to the procedure of driving the quality of the first analysis data.

That is, the data estimating unit 120 may calculate the quality of the second analysis data according to at least one of a frequency of a term included in the comment information allocated to a part of the second analysis data and a frequency of a term included in the interpretation information through the morphological analyzer 160.

In this case, at least one of the comment information and the interpretation information may be allocated to each of a plurality of time series data included in the second analysis data.

Accordingly, the data estimating unit 120 may calculate a frequency TF of a term provided from a single time series data of the second analysis data and a frequency DF of a term provided from a plurality of time series data of the second analysis data.

The data estimating unit 120 may calculate the importance of the term allocated to the second analysis data by calculating the TF/DF, and may calculate the qualitative quality Ta of the second analysis data according to the importance of each term.

Since the method of calculating the qualitative quality Ta according to the importance of the term was previously described in detail, the description thereof is omitted.

Meanwhile, the data estimating unit 120 may calculate the quality of the second analysis data according to a length of an interval corresponding to at least one of the comment information and the interpretation information allocated to a part of the second analysis data.

When the second analysis data includes a plurality of time series data, the data estimating unit 120 may calculate the quantitative quality Tb according to an interval of the time series data to which at least one of the comment information and the interpretation information and the whole interval of the time series data.

Since the method of calculating the quantitative quality Tb was previously described in detail, the description thereof is omitted.

As described above, the data estimating unit 120 may automatically derive the qualitative quality Ta and the quantitative quality Tb of the second analysis data. In addition, the data estimating unit 120 may automatically derive a total quality QU by integrally considering the qualitative quality Ta and the quantitative quality Tb.

Since the method of calculating the total quality QU was previously described in detail, the description thereof is omitted.

As described above, the apparatus for estimating a usability and a quality of data according to an embodiment of the present invention may automatically derive the quality of the second analysis data through the established database 110.

Meanwhile, as shown in FIG. 2, the data estimating unit 120, the qualitative quality calculating unit 140, the quantitative quality calculating unit 150, the morphological analyzer 160, and the PLS performing unit 130 may be implemented in the form of a computer program.

Such a computer program may be installed in a computer readable recording medium 170.

The apparatus for estimating a usability and a quality of data according to an embodiment of the present invention may include various devices such as a smart phone, a notebook computer, a PC, and a tablet PC, but the present invention is not limited thereto.

Constituent elements of the apparatus for estimating a usability and a quality of data according to an embodiment of the present invention may communicate with each other through at least one communication but or signal line.

The apparatus for estimating a usability and a quality of data according to an embodiment of the present invention may include the smaller or larger number of constituent elements shown in FIG. 2. The apparatus for estimating a usability and a quality of data according to an embodiment of the present invention shown in FIG. 2 may be implemented by hardware, software, or a combination thereof.

A recording medium 170 may store a software constituent element. The software constituent element may include an operating system OS, the database 110, the data estimating unit 120, the qualitative quality calculating unit 140, the quantitative quality calculating unit 150, the morphological analyzer 160, and the PLS performing unit 130.

The recording medium 170 may be CD, DVD, USB, a hard disk, RAM, a flash memory, or a remote storage device which is accessible through a network.

The operating system OS may be LINUX, UNIX, Windows based server OS, iOS, an Android OS, OS for a windows based PC, but the present invention is not limited thereto.

A CPU 180 may load and execute the software constituent element stored in the recording medium 170.

A memory controller 190 may control other constituent elements such as a CPU or peripheral interface 200 to access the recording medium 170.

A communication unit 210 may include a communication module in order to communicate with the first data generating 10 and the second data generating 20. In FIG. 2, the second data generator 20 may generate the second analysis data, but the present invention is not limited thereto. The first data generating unit 10 may generate the second analysis data.

A peripheral interface 200 may connect the CPU and the recording medium 170 with an input device 230 such as a mouse, a keyboard, or a touch screen.

An input device controller 220 may receive an electric signal from the input device 230 and convert the electric signal to be suitable to a standard of the communication bus or the signal line.

Although embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. An apparatus for estimating a usability and a quality of data, the apparatus comprising:
a database configured to store a quality of first analysis data according to comment information on a data pattern included in the first analysis data and interpretation information on a part corresponding to a search pattern among the first analysis data; and
a data estimating unit configured to automatically derive a quality of second analysis data according to the comment information and the interpretation information allocated to a part of the second analysis data corresponding to the data pattern and the search pattern.

2. An apparatus for estimating a usability and a quality of data, the apparatus comprising:
a database configured to store a quality of first analysis data according to comment information on a data pattern included in the first analysis data; and
a data estimating unit configured to automatically derive a quality of second analysis data according to the comment information allocated to a part of the second analysis data similar to or identical with the data pattern.

3. An apparatus for estimating a usability and a quality of data, the apparatus comprising:
a database configured to store a quality of first analysis data according to interpretation information on a part corresponding to a search pattern among the first analysis data; and
a data estimating unit configured to automatically derive a quality of second analysis data according to the interpretation information allocated to a part of the second analysis data similar to or identical with the search pattern.

4. The apparatus of claim 1, wherein the first analysis data comprises a plurality of time series data, and
the data estimating unit derives the quality of the second analysis data through reference time series data among the plurality of time series data.

5. The apparatus of claim 2, wherein the first analysis data comprises a plurality of time series data, and
the data estimating unit derives the quality of the second analysis data through reference time series data among the plurality of time series data.

6. The apparatus of claim 3, wherein the first analysis data comprises a plurality of time series data, and
the data estimating unit derives the quality of the second analysis data through reference time series data among the plurality of time series data.

7. The apparatus of claim 4, wherein the reference time series data comprises time series data having the best quality among the plurality of time series data.

8. The apparatus of claim 1, further comprising a qualitative quality calculating unit configured to calculate the quality of the first analysis data according to a frequency of a term included in the comment information and a frequency of a term included in the interpretation information through a morphological analyzer.

9. The apparatus of claim 2, further comprising a qualitative quality calculating unit configured to calculate the quality of the first analysis data according to a frequency of a term included in the comment information through a morphological analyzer.

10. The apparatus of claim 3, further comprising a qualitative quality calculating unit configured to calculate the quality of the first analysis data according to a frequency of a term included in the interpretation information through a morphological analyzer.

11. The apparatus of claim 1, wherein the data estimating unit calculates the quality of the second analysis data according to a frequency of a term included in the comment information and a frequency of a term included in the interpretation information allocated to a part of the second analysis data through a morphological analyzer.

12. The apparatus of claim 2, wherein the data estimating unit calculates the quality of the second analysis data according to a frequency of a term included in the comment information allocated to a part of the second analysis data through a morphological analyzer.

13. The apparatus of claim 3, wherein the data estimating unit calculates the quality of the second analysis data according to a frequency of a term included in the interpretation information allocated to a part of the second analysis data through a morphological analyzer.

14. The apparatus of claim 1, further comprising a quantitative quality calculating unit configured to calculate the quality of the first analysis data according to a length of an interval corresponding to the comment information and the interpretation information.

15. The apparatus of claim 2, further comprising a quantitative quality calculating unit configured to calculate the quality of the first analysis data according to a length of an interval corresponding to the comment information.

16. The apparatus of claim 3, further comprising a quantitative quality calculating unit configured to calculate the quality of the first analysis data according to a length of an interval corresponding to the interpretation information.

17. The apparatus of claim 1, wherein the data estimating unit calculates the quality of the second analysis data according to a length of an interval corresponding to the comment information and the interpretation information allocated to a part of the second analysis data.

18. The apparatus of claim 2, wherein the data estimating unit calculates the quality of the second analysis data according to a length of an interval corresponding to the comment information allocated to a part of the second analysis data.

19. The apparatus of claim 3, wherein the data estimating unit calculates the quality of the second analysis data according to a length of an interval corresponding to the interpretation information allocated to a part of the second analysis data.

20. The apparatus of claim 1, wherein the data estimating unit derives a part of the second analysis data corresponding to the data pattern by performing convolution with respect to an area of the first analysis data corresponding to the data pattern and the second analysis data.

21. The apparatus of claim 2, wherein the data estimating unit derives a part of the second analysis data corresponding to the data pattern by performing convolution with respect to an area of the first analysis data corresponding to the data pattern and the second analysis data.

22. The apparatus of claim 1, wherein the data estimating unit derives a part of the second analysis data corresponding to the search pattern among the segmented second analysis data.

23. The apparatus of claim 3, wherein the data estimating unit derives a part of the second analysis data corresponding to the search pattern among the segmented second analysis data.
